(19) United States
(12) Patent Application Publication
(10) Pub. No.: US 2025/0314750 A1
(43) Pub. Date: Oct. 9, 2025

(54) RADAR CONTROL METHOD, DEVICE, TERMINAL EQUIPMENT AND STORAGE MEDIUM

(71) Applicant: SUTENG INNOVATION TECHNOLOGY CO., LTD., Shenzhen (CN)

(72) Inventors: JinWen XIE, Shenzhen (CN); Huazhou CHEN, Shenzhen (CN)

(73) Assignee: SUTENG INNOVATION TECHNOLOGY CO., LTD., Shenzhen (CN)

(21) Appl. No.: 19/098,954

(22) Filed: Apr. 2, 2025

(30) Foreign Application Priority Data
Apr. 7, 2024 (CN) 202410414042.3

(51) Int. Cl. G01S 7/484; G01S 7/48

(52) U.S. Cl. CPC G01S 7/484; G01S 7/4802

(57) ABSTRACT

The present application is applicable to the technology field of radar systems, and provides a radar control method, device, terminal equipment and storage medium, the method comprising: controlling the radar to transmit detection signals based on a preset transmission coding mode; the preset transmission coding mode is to control the radar to transmit the detection signals according to the transmission code corresponding to the transmission interval in the current transmission cycle; wherein the transmission cycle includes a random coding area and an analysis area; the random coding area is configured to control the overall offset of the analysis area in the current measurement cycle, and by introducing the random coding area, anti-reciprocal interference can be effectively achieved, and the probability of crosstalk can be reduced as much as possible.

### CROSS-REFERENCE TO RELATED APPLICATION

The present application claims the benefit of priority to Chinese Patent Application No. 202410414042.3, filed on Apr. 7, 2024, which is hereby incorporated by reference in its entirety.

### TECHNICAL FIELD

The present application relates to the field of radar technology, and in particular to a radar control method, device, terminal equipment, and storage medium.

### BACKGROUND

For radar based on vertical cavity surface emitting laser (VCSEL) transmission and silicon photomultiplier (SiPM) array reception, the physical isolation between adjacent channels is small, which aggravates the degree of crosstalk between channels. In order to reduce the crosstalk between channels, transmission coding and appropriate filtering strategies can be configured to distinguish between real echoes and crosstalk echoes. However, due to the large number of channels and the number of transmission codes, there will be concurrent channels, and there will be certain interference between concurrent channels. When the target object is a high reflectivity object, since the energy of the reflected echo is very high, the crosstalk generated by the channel will cover most of the channels, making it impossible for both the transmission coding and the filtering strategies to distinguish between real echoes and crosstalk echoes. Therefore, it is necessary to identify the high-reflectivity channel and switch the high-reflectivity channel to high-reflectivity coding to improve the anti-crosstalk capability of the radar system.

However, for the ultra-long-range radar system, the SiPM array is very easy to saturate at close range, which will cause the distinction between high-reflectivity echoes and non-high-reflectivity echoes to deteriorate sharply, leading to problems such as non-high-reflectivity misidentification and high-reflectivity missed identification. Non-high-reflectivity misidentification will cause the non-high-reflectivity channel to switch to high-reflectivity coding, thereby causing concurrency with the real high-reflectivity channel. High-reflectivity missed identification will cause the high-reflectivity channel to fail to switch to high-reflectivity coding in time, which will continue to cause crosstalk to other channels.

### SUMMARY

Embodiments of the present application provide a radar control method, device, terminal equipment and storage medium, which can improve the anti-crosstalk capability of the radar system.

In a first aspect, an embodiment of the present application provides a radar control method, including:
controlling the radar to transmit detection signals based on a preset transmission coding mode, where the preset transmission coding mode is to control the radar to transmit the detection signals according to the transmission code corresponding to the transmission interval in the current transmission cycle, and the transmission cycle includes a random coding area and an analysis area; and
determining the transmission coding mode of the next transmission cycle according to the received echo data, and controlling the radar to transmit the detection signals again at the beginning of the next transmission cycle based on the transmission coding mode of the next transmission cycle.

In an embodiment, determining the transmission coding mode of the next transmission cycle according to the received echo data includes:
identifying high reflectivity objects according to the echo data of the analysis area; and
adjusting the transmission coding mode of the next transmission cycle of the identified high-reflectivity channel to high-reflectivity coding.

In an embodiment, the analysis area includes at least two sub-analysis areas, and transmission energies of different sub-analysis areas are different.

In an embodiment, the analysis area includes a first sub-analysis area and a second sub-analysis area, the transmission energy of the first sub-analysis area is less than the transmission energy of the second sub-analysis area, the echo data corresponding to the first sub-analysis area is configured for high reflectivity object identification, and the echo data corresponding to the second sub-analysis area is configured for distance measurement.

In an embodiment, determining the transmission coding mode of the next transmission cycle according to the received echo data includes:
identifying high reflectivity objects according to the echo data of the first sub-analysis area and determining the high-reflectivity channel; and
adjusting the transmission coding mode of the second sub-analysis area of the identified high-reflectivity channel to high-reflectivity coding.

In an embodiment, the radar control method further includes:
determining the reflectivity of an object at a reflectivity splicing distance according to the echo data of the first sub-analysis area; and
determining the reflectivity of an object exceeding the reflectivity splicing distance according to the echo data of the second sub-analysis area, where the reflectivity splicing distance is determined according to the transmission energy of the first sub-analysis area.

In an embodiment, the random coding area is configured to jitter the first sub-analysis area or the second sub-analysis area.

In an embodiment, the random coding area adopts offset coding.

In a second aspect, an embodiment of the present application provides a radar control device, including:
a control unit, configured to control the radar to transmit detection signals based on a preset transmission coding mode, where the preset transmission coding mode is configured to control the radar to transmit the detection signals according to the transmission code corresponding to the transmission interval in the current transmission cycle, and the transmission cycle includes a random coding area and an analysis area; and
a coding adjustment unit, configured to determine the transmission coding mode of the next transmission cycle according to the received echo data, and control the radar to transmit the detection signals again at the beginning of the next transmission cycle based on the transmission coding mode of the next transmission cycle.

In a third aspect, an embodiment of the present application provides a terminal equipment, including a processor, a memory, and a computer program stored in the memory and executable on the processor, where the processor implements the method as described in the first aspect or any optional method of the first aspect when executing the computer program.

In a fourth aspect, an embodiment of the present application provides a computer-readable storage medium, where the computer-readable storage medium stores a computer program, and when the computer program is executed by a processor, the method described in the first aspect or any optional method of the first aspect is implemented.

In a fifth aspect, an embodiment of the present application provides a computer program product. When the computer program product is run on a terminal equipment, the terminal equipment executes the method described in the first aspect or any optional method of the first aspect.

Embodiments of the present application provide a radar control method, device, terminal equipment, and computer-readable storage medium, which can divide the radar transmission cycle into a random coding area and an analysis area. The random coding area is configured to control the overall offset of the analysis area in the current measurement cycle. By introducing the random coding area, anti-reciprocal interference can be effectively achieved, and the probability of crosstalk can be reduced as much as possible.

### BRIEF DESCRIPTION OF DRAWINGS

In order to more clearly illustrate the embodiments of the present application or the technical solutions in the prior art, the drawings are briefly introduced below. The drawings described below are only some embodiments of the present application.

FIG. 1 is a schematic diagram of the structure of a LiDAR in an embodiment of the present application;

FIG. 2 is a schematic diagram of a scenario of crosstalk between channels;

FIG. 3 is a schematic diagram of high-reflectivity coding anti-interference;

FIG. 4 is a schematic diagram showing the ability of an ultra-long-range radar system to distinguish objects with different reflectivity at different distances; the discrimination of objects with different reflectivity at different distances

FIG. 5 is a schematic diagram of the implementation process of a radar control method provided by the embodiment of the present application;

FIG. 6 is a schematic diagram of the division of the transmission cycle provided in an embodiment of the present application;

FIG. 7 is another schematic diagram of the division of the transmission cycle provided by the embodiment of the present application;

FIG. 8 is a schematic diagram of the application mode of the first sub-analysis area and the second sub-analysis area provided in an embodiment of the present application;

FIG. 9 is another schematic diagram of application mode of the first sub-analysis area and the second sub-analysis area provided in an embodiment of the present application;

FIG. 10 is a schematic diagram of the discrimination of objects with different reflectivity in the first sub-analysis area and the second sub-analysis area provided in an embodiment of the present application;

FIG. 11 is a schematic diagram of the division of the analysis area provided by an embodiment of the present application;

FIG. 12 is a schematic diagram of the length of a domain similarity judgment window;

FIG. 13 is another schematic diagram of the division of the transmission cycle provided by the embodiment of the present application;

FIG. 14 is a schematic diagram of the discrimination of objects with different reflectivity corresponding to different analysis areas in the transmission cycle shown in FIG. 13;

FIG. 15 is a schematic diagram of the structure of a radar control device provided in an embodiment of the present application;

FIG. 16 is a schematic diagram of the structure of a terminal equipment provided in an embodiment of the present application; and

FIG. 17 is a schematic diagram of the structure of a terminal equipment provided in an embodiment of the present application.

### DETAILED DESCRIPTION

In the following description, details such as system structures, technologies, etc., are provided for the purpose of illustration rather than limitation, so as to provide a thorough understanding of the embodiments of the present application. In other cases, detailed descriptions of well-known systems, devices, circuits, and methods are omitted to prevent unnecessary details from obstructing the description of the present application.

The term “and/or” used in the specification of this application and the appended claims refers to any combination of one or more of the associated listed items and all possible combinations, and includes these combinations. In addition, in the description of the specification of this application and the appended claims, the terms “first,” “second,” “third,” etc., are only used to distinguish the description and cannot be understood as indicating or implying relative importance.

References to “an embodiment” or “some embodiments” etc., described in the specification of the present application mean that one or more embodiments of the present application include specific features, structures or characteristics described in conjunction with the embodiment. Thus, the statements “in one embodiment,” “in some embodiments,” “in some other embodiments,” “in some other embodiments,” etc., that appear in different places in the specification do not necessarily refer to the same embodiment, but mean “one or more but not all embodiments,” unless otherwise specifically emphasized in other ways. The terms “including,” “comprising,” “having” and their variations all mean “including but not limited to,” unless otherwise specifically emphasized in other ways.

LiDAR is a radar system that emits laser beams to detect the position, speed, and other information of the target. In addition to detecting the distance of an object, it can also detect the reflectivity of the object for target identification. The specific working principle of LiDAR is to transmit detection signals to the target. After reaching the target, the detection signals will be reflected by the target object to form echo data. LiDAR receives the signals (echo data) reflected by the target, and then can determine the relevant information of the target based on the echo data, such as the target distance, position, height, speed, posture, shape, reflectivity, etc., thereby realizing target detection, target tracking, and target identification. The reflectivity of an object refers to the percentage of the radiation energy reflected by the object to the total radiation energy of the incident signal. The reflectivity of different objects is different. The reflectivity of an object is mainly determined by factors such as the surface properties of the object, the wavelength of the incident signal, and the angle of incidence.

In specific applications, according to the distance measurement method, LiDAR can be divided into time of flight (ToF) ranging method, frequency modulated continuous wave (FMCW) ranging method, and triangulation ranging method. The time of flight (TOF) ranging method refers to a method in which a group of infrared lights (or laser pulses) invisible to human eyes are emitted outward, reflected after encountering an object, and reflected to the radar. The time difference or phase difference from transmission to reflection back to the radar is calculated to determine the distance of the object.

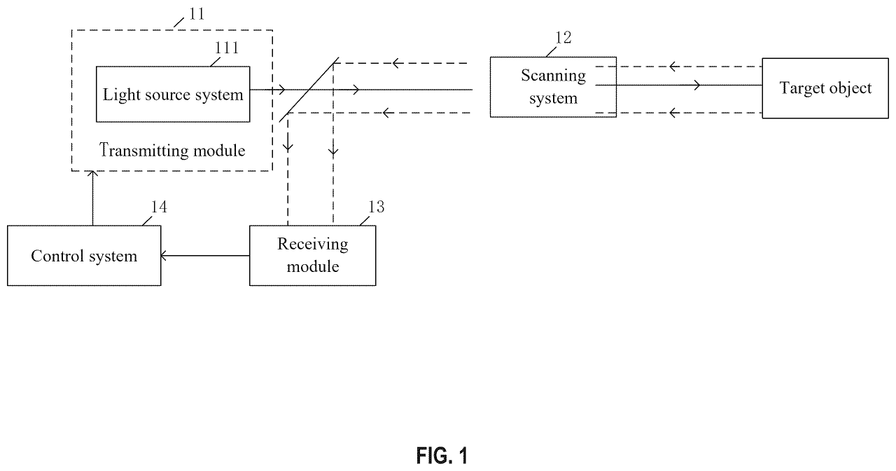

In an embodiment, please refer to FIG. 1, which shows a schematic diagram of the structure of a LiDAR. As shown in FIG. 1, the LiDAR 10 generally includes a transmitting module 11, a scanning system 12, a receiving module 13 and a control system 14. The transmitting module 11 may include a light source system 111.

The light source system 111 is configured to generate laser beams required for the LiDAR 10 to detect. In some embodiments, the above-mentioned light source system 111 may include optical devices such as a laser and an emitting lens group. The above-mentioned scanning system 12 is configured to deflect the laser beams generated by the light source system 111 at an angle so that the laser beams can hit different positions at different times. The scanning system 12 can be a mechanical scanning system (i.e., a rotating drive platform) or a semi-solid scanning system (i.e., a rotating mirror, a galvanometer, or a combination of the two). The present application does not impose a sole restriction on the form of the scanning system. The LiDAR in the present application can also be a solid-state LiDAR, that is, scanning is achieved by controlling light sources at different angles to emit lights in sequence. After the laser beams emitted by the light source system reach the target object and are reflected by the target object, the reflected light pulse will be received by the receiving sensor (sensor) 131 in the receiving module 13, and then the echo signals processing circuit processes the echo signals to generate corresponding detection information.

It should be noted that the above light source system can adopt devices such as vertical cavity surface emitting laser (VCSEL) or edge emitting laser (EEL), and the above sensor can be composed of silicon photomultiplier (SiPM) array. The SiPM array is composed of a large number (generally including hundreds to thousands) of avalanche diode (APD) units, each of which is composed of an avalanche diode and a large resistance quenching resistor in series, and these avalanche diode units are connected in parallel to form a surface array (i.e., the above SiPM array).

After the reverse bias voltage is applied to the SiPM array, the depletion layer of the APD in each avalanche diode unit has a high electric field. At this time, if a photon hits from the outside, it will cause Compton to scatter with the electron-hole pairs in the APD, knocking out electrons or holes. The high-energy electrons and holes are then accelerated in the electric field, knocking out a large number of secondary electrons and holes, i.e., avalanche. At this time, the current in each APD unit suddenly increases, and the voltage dropped on the quenching resistor also increases. The electric field in the APD becomes smaller instantly, i.e., the avalanche stops after the APD outputs an instantaneous current pulse. The quenching resistors in different APD units have the same resistance value, so theoretically, each APD unit will output pulses of equal size. Within the dynamic range of the SiPM array, the size of its output current is proportional to the number of APD units that have avalanche, i.e., the stronger the reflected light received, the greater the current output by the SiPM array.

For radars based on VCSEL transmission and SiPM array reception, the degree of crosstalk between channels is aggravated due to the low physical isolation between adjacent channels. In order to reduce the crosstalk between channels, transmission coding and appropriate filtering strategies can be configured to distinguish between real echoes and crosstalk echoes. At the same time, with the improvement of the degree of integration of radar systems, the number of channels will be greater than the number of transmission codes, so there will be concurrent channels, and there will be certain interference between concurrent channels. When the target object is a high reflectivity object, since the energy of the reflected echo is very high, the crosstalk generated by the channel will cover most of the channels, making it impossible for both the transmission coding and the filtering strategies to distinguish between the real echo and the crosstalk echo.

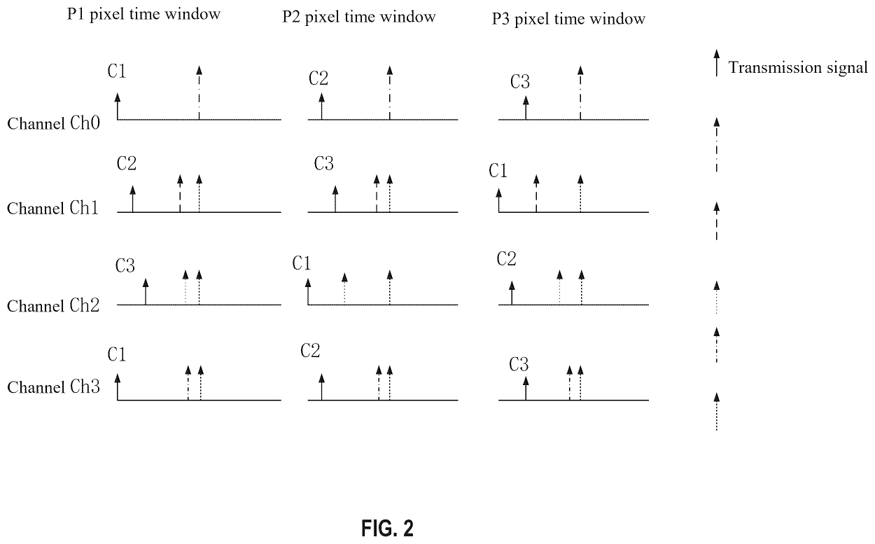

In an embodiment, please refer to FIG. 2, which shows a schematic diagram of a scenario of crosstalk between channels. As shown in FIG. 2, in the P1 pixel time window, channel Ch0 and channel Ch3 both adopt C1 coding, that is, channel Ch0 and channel Ch3 are concurrent channels (using the same channel coding) in the P1 pixel time window; in the P1 pixel time window, channel Ch1 adopts C2 coding, channel Ch2 adopts C3 coding; in the P2 pixel time window, channel Ch0 and channel Ch3 both adopt C2 coding, channel Ch1 adopts C3 coding, channel Ch2 adopts C1 coding; in the P3 pixel time window, channel Ch0 and channel Ch3 both adopt C3 coding, channel Ch1 adopts C3 coding, channel Ch2 adopts C1 coding; in the P3 pixel time window, channel Ch0 and channel Ch3 both adopt C3 coding, channel Ch3 adopts C4 . . . 3 coding, channel Ch2 adopts C1 coding; in the P3 pixel time window, channel Ch0 and channel Ch3 both adopt C3 coding, channel Ch3 adopts C4 coding, channel Ch1 adopts C3 coding, channel Ch2 adopts C3 coding, channel Ch2 adopts C1 coding, in Ch1 adopts C1 coding, and channel Ch2 adopts C2 coding. Since the detection signals emitted by the Ch0 channel are reflected by a high reflectivity object, the echo data received by Ch0 will generate crosstalk to other channels (Ch1 channel, Ch2 channel, and Ch3 channel). The real echo and crosstalk signals can be identified by calculating the similarity of echo distances of adjacent pixels. Since channels Ch0 and Ch3 adopt the same channel coding, which is equivalent to concurrency, the crosstalk signals and the real echo data have the same similarity, and it is easy to select the wrong echo data, that is, the crosstalk signals are mistakenly identified as the real echo data.

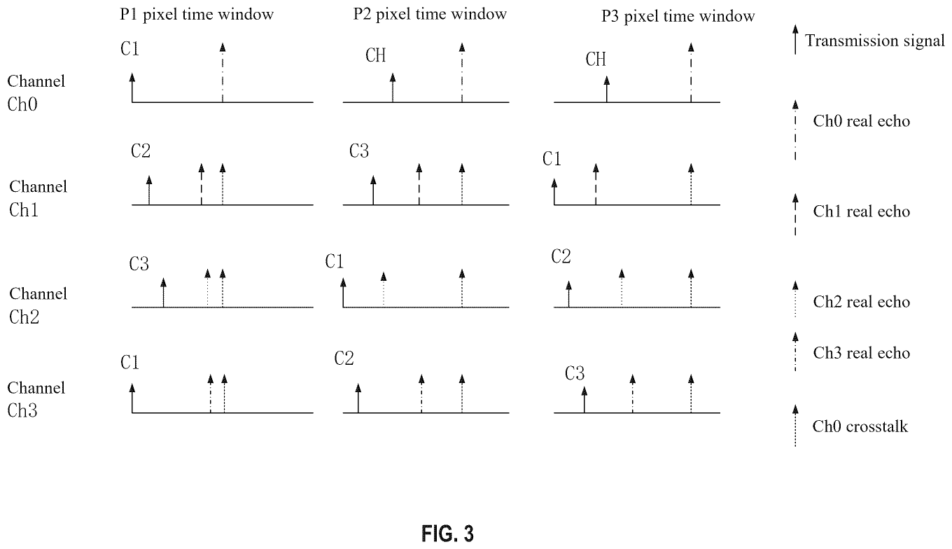

When it is determined that the object detected by channel Ch0 is a high reflectivity object (referred to as high-reflectivity echo identification, and channel Ch0 is referred to as a high-reflectivity channel), the coding of channel Ch can be switched to high-reflectivity coding, so that the original concurrent channel (Ch3) can perform echo identification. In an embodiment, please refer to FIG. 3, which is a schematic diagram of high-reflectivity coding anti-interference. In the P1 pixel time window, channel Ch0 and channel Ch3 are in a concurrent state. In the P2 pixel time window and the P3 pixel time window, channel Ch0 is switched to high-reflectivity coding. After the switch, the crosstalk of channel Ch0 to channel Ch3 is at different positions in the three pixel time windows, so channel Ch3 can effectively identify the real echo and crosstalk signals.

The switching of high-reflectivity coding depends on the recognition of high-reflectivity echoes. Whether the echo data is echo data reflected by a high reflectivity object can be determined based on indicators such as the amplitude, pulse width, echo area, echo power, and echo energy of the echo data.

The process of judging whether an echo is echo data of the reflectivity of an object with high reflectivity based on the amplitude, pulse width, echo area, echo power, echo energy, and other indicators of the echo data can be referred to in existing related schemes, and the present application will not go into details.

The high-reflectivity channel mentioned in the embodiments of the present application is a channel that receives echo data of objects with high reflectivity, such as the above-mentioned channel Ch0.

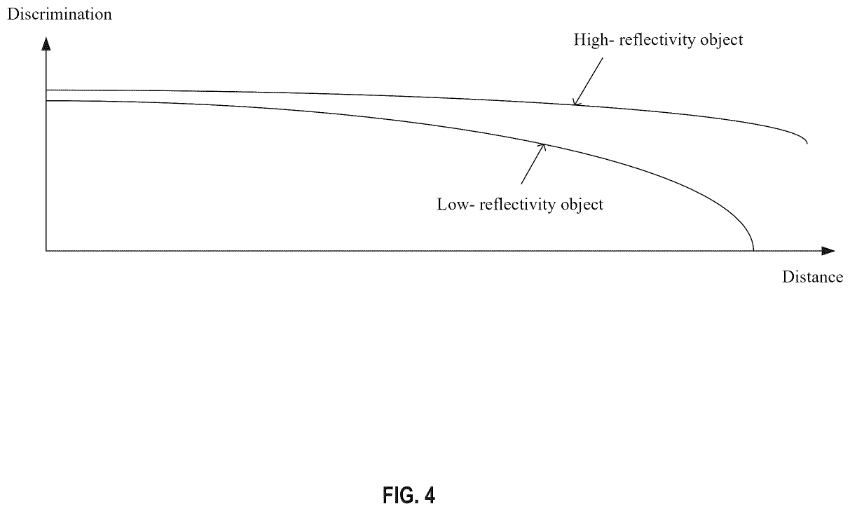

Refer to FIG. 4, which shows a schematic diagram of the discrimination of objects with different reflectivity at different distances. For ultra-long-range radar systems, the SiPM array is very easy to saturate at close range, which will cause the discrimination between high-reflectivity echoes and non-high-reflectivity echoes to deteriorate sharply, and there will be problems such as non-high-reflectivity misidentification and high-reflectivity missed identification. Non-high-reflectivity misidentification will cause the non-high-reflectivity channel to switch to high-reflectivity coding, thereby causing concurrency with the real high-reflectivity channel. High-reflectivity missed identification will cause the high-reflectivity channel to not switch to high-reflectivity preset coding in time, which will continue to cause crosstalk to other channels.

An embodiment of the present application provides a radar control method, which divides the radar's transmission period into a random coding area and an analysis area. The random coding area is configured to control the overall offset of the analysis area in the current measurement period. By introducing the random coding area, anti-reciprocal interference can be effectively achieved, and the probability of crosstalk can be reduced as much as possible.

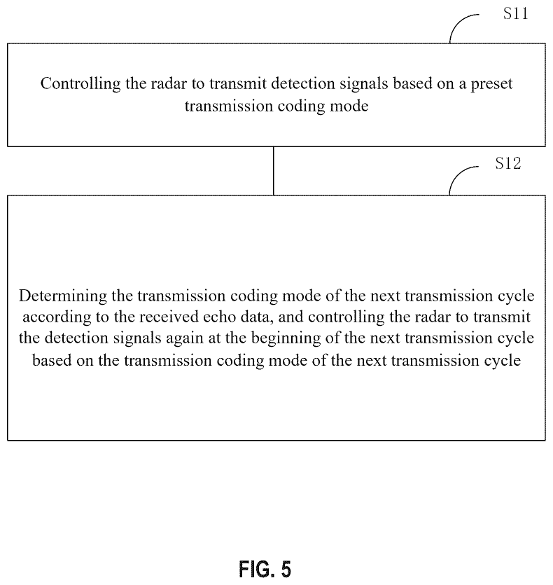

Refer to FIG. 5, which shows the implementation process of a radar control method provided in an embodiment of the present application. As shown in FIG. 5, the radar control method may include S11-S12.

The execution subject of the radar control method provided in embodiments of the present application can be the above-mentioned LiDAR 10, the control system in the LiDAR 10. In some embodiments, the execution subject of the above-mentioned radar control method can also be a terminal device connected to the LiDAR 10 for communication. The above-mentioned terminal device can be a terminal such as a mobile phone, a desktop computer, a laptop computer, a tablet computer or a wearable device, or a cloud server, a radar-assisted computer, and other devices in various application scenarios. The following is an embodiment of the execution subject being the LiDAR 10:
in S11, controlling the radar to transmit detection signals based on a preset transmission coding mode.

In a specific application, the above-mentioned preset transmission coding mode is to control the radar to transmit the detection signals according to the transmission code of the transmission interval in the current transmission cycle.

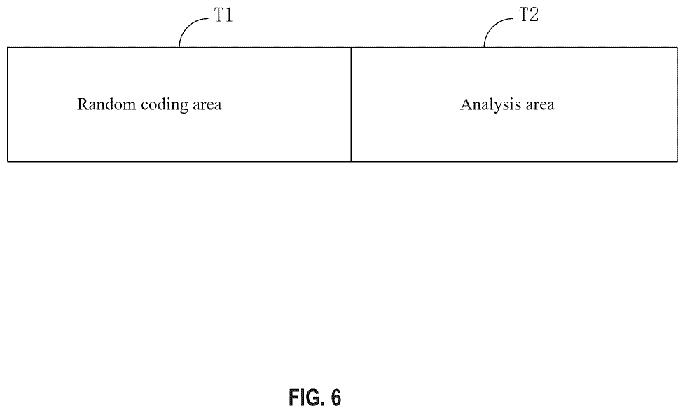

Referring to FIG. 6, in an embodiment of the present application, the transmission period T is divided into a random coding area T1 and an analysis area T2.

The random coding area T1 may adopt random coding, and the analysis area T2 may adopt channel coding and/or high-reflectivity coding.

The random coding area is configured to control the overall offset of the analysis area in the current scanning cycle, that is, the length of the random coding area determines the start time of the analysis area, and the end time of the random coding area is the start time of the analysis area.

The random coding area can adopt random coding to determine the transmission time. The random coding can adopt a pseudo-random number generator such as an m-sequence and a gold sequence to construct a pseudo-random sequence of finite length. The pseudo-random sequence refreshes the random coding according to the transmission cycle.

In some embodiments of the present application, the random coding area may adopt offset coding.

The interval length of the random coding area is determined by the pseudo-random sequence range and the unit time. The larger the pseudo-random sequence range, the larger the maximum effective value of the random sequence, and the better the radar system's anti-crosstalk performance. However, the required random coding area occupancy time is also longer. Therefore, the pseudo-random sequence range can be comprehensively considered based on the transmission cycle length and the anti-crosstalk performance.

It should be noted that the above-mentioned unit time is related to the detection accuracy of the radar. For a radar with a detection accuracy of 20 meters, the unit time may be 4 nanoseconds.

In embodiments of the present application, the random coding area can be configured to counter crosstalk. The analysis area is configured for target detection, and the radar can identify high reflectivity objects based on the echo data of the analysis area. When a high reflectivity object is identified, the coding of the analysis area of the next cycle can be switched to high-reflectivity coding, thereby reducing the impact of high reflectivity objects on the detection results.

In some embodiments of the present application, the above-mentioned analysis area T2 can be composed of at least two sub-analysis areas, and the transmission energy of each sub-analysis area is different.

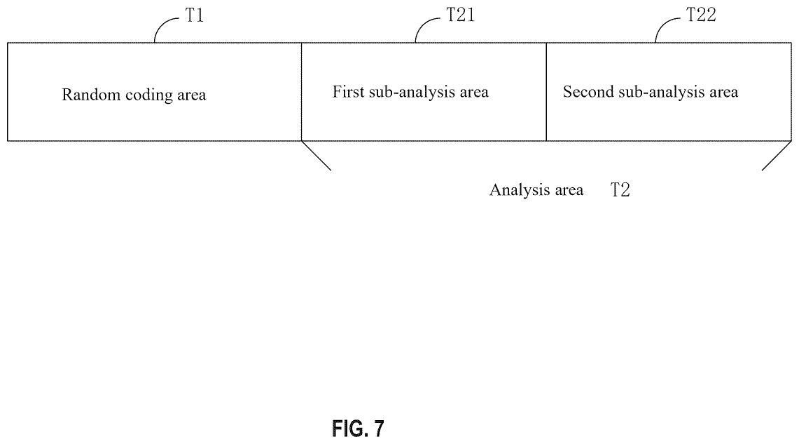

In an embodiment, refer to FIG. 7, which shows a schematic diagram of the division of the transmission cycle provided in another embodiment of the present application. As shown in FIG. 7, the above-mentioned analysis area T2 may include a first sub-analysis area T21 and a second sub-analysis area T22.

The first sub-analysis area T21 may adopt channel coding and/or high-reflectivity coding, and the second sub-analysis area T22 may also adopt channel coding and/or high-reflectivity coding.

In an embodiment of the present application, the transmission energy of the first sub-analysis area T21 is less than the transmission energy of the second sub-analysis area T22. The echo data of the first sub-analysis area T21 is configured to distinguish high reflectivity objects and reflectivity mapping, and the echo data of the second sub-analysis area T22 is configured for ranging and reflectivity measurement of long-distance objects.

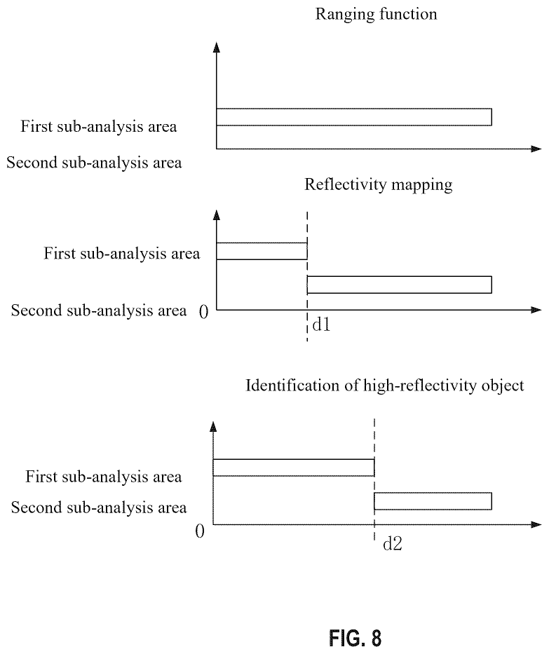

In an embodiment, refer to FIG. 8, which is a schematic diagram of the application mode of the first sub-analysis area and the second sub-analysis area provided in an embodiment of the present application. As shown in FIG. 8, for the ranging function, the echo data corresponding to the second sub-analysis area is configured to perform ranging within the full range of distances; for reflectivity mapping, within the 0-d1 distance, the echo data corresponding to the first sub-analysis area is configured to perform reflectivity mapping, and for objects exceeding the d1 distance, the echo data corresponding to the second sub-analysis area is configured to perform reflectivity mapping; for the identification of high reflectivity objects, within the 0-d2 distance, the echo data corresponding to the first sub-analysis area is configured to identify high reflectivity objects (that is, the identification of high reflectivity objects at close range is realized by adopting the echo data corresponding to the first sub-analysis area with lower transmission energy, thereby improving the identification accuracy of high reflectivity objects at close range), and for objects exceeding d2, the echo data corresponding to the second sub-analysis area is configured to identify high reflectivity objects.

d1 represents the reflectivity splicing distance, which is determined according to the transmission energy of the first sub-analysis area. The greater the transmission energy of the first sub-analysis area, the longer the reflectivity splicing distance. d2 represents the high-reflectivity identification splicing distance. Considering the dynamic range of reflectivity, d1<d2 is satisfied.

In an embodiment of the present application, the echo data of the first sub-analysis area T21 can also be configured for ranging, that is, to achieve ranging of the objects at close range.

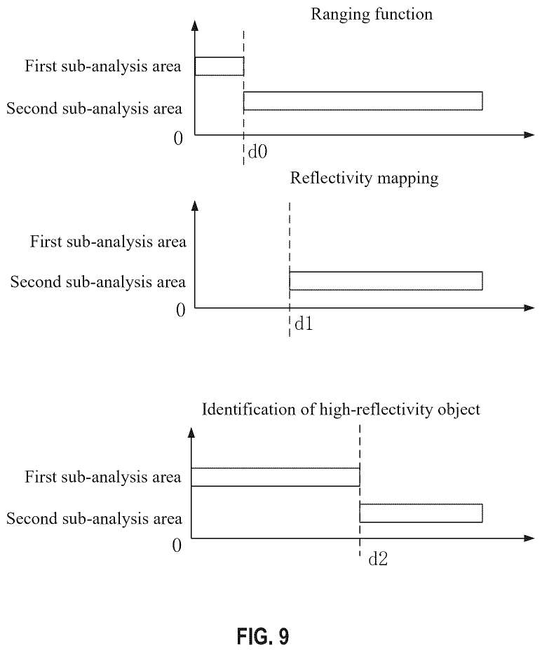

In an embodiment, refer to FIG. 9, which is a schematic diagram of the application of the first sub-analysis area and the second sub-analysis area provided in another embodiment of the present application. As shown in FIG. 9, for the ranging function, within the distance of 0-d0, the echo data corresponding to the first sub-analysis area is configured for ranging (that is, the echo data corresponding to the first sub-analysis area participates in the ranging of the object at close range), and for the object exceeding the distance d0, the echo data corresponding to the second sub-analysis area is configured for ranging; for the reflectivity identification function, within the distance of 0-d1, the echo data corresponding to the first sub-analysis area is configured to determine the reflectivity of the object, and for the object exceeding the distance d1, the echo data corresponding to the second sub-analysis area is configured to determine the reflectivity of the object; for the identification function of high reflectivity objects, within the distance of 0-d2, the echo data corresponding to the first sub-analysis area is configured to identify high reflectivity objects (that is, the identification of high reflectivity objects at close range is realized by adopting the echo data corresponding to the first sub-analysis area with lower transmission energy, thereby improving the identification accuracy of close-range high reflectivity objects), and for objects exceeding d2, the echo data corresponding to the second sub-analysis area is configured to identify high reflectivity objects.

In some embodiments, only the echo data corresponding to the second sub-analysis area may be configured to determine the reflectivity of the object. Since the transmission energy corresponding to the second sub-analysis area is larger, objects at a farther distance can be detected. Therefore, only the second sub-analysis area can be configured to determine the reflectivity of the object.

It should be noted that the above-mentioned channel coding refers to a fixed transmission coding mode preset in the radar system, that is, the transmission jitter of different channel codes is different. Multiple channel codes can be set in each radar system. At the beginning of the first transmission cycle, since it is unclear whether there is a high-reflectivity channel, the first sub-analysis area T21 and the second sub-analysis area T22 can both adopt fixed-coded channel coding to perform transmission control. After the high-reflectivity channel is determined, the coding of the high-reflectivity channel can be switched to the high-reflectivity coding in the next transmission cycle.

The high-reflectivity coding can be a transmission coding mode with dynamically changing transmission jitter time.

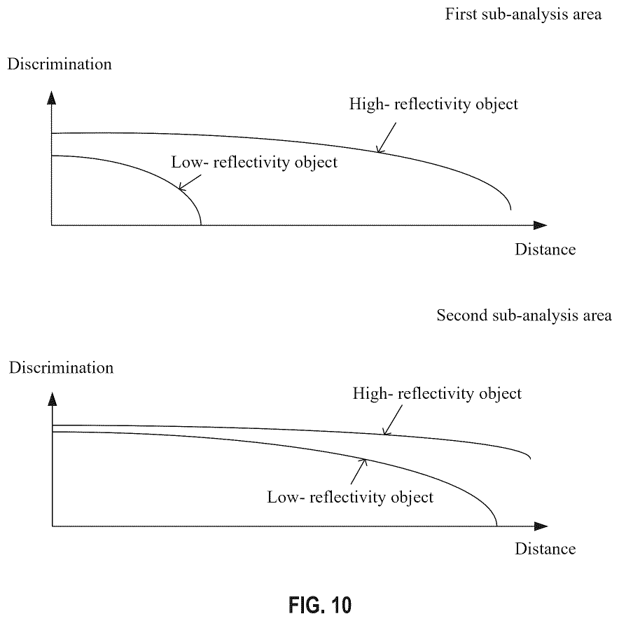

Refer to FIG. 10, which shows a schematic diagram of the discrimination of objects with different reflectivity in the first sub-analysis area and the second sub-analysis area. As shown in FIG. 10, the first sub-analysis area T21 adopts a lower transmission energy to emit detection signals, which can effectively improve the discrimination of the reflectivity of the objects at close range.

In a specific application, the effective distance of the first sub-analysis area is shorter than that of the second sub-analysis area, so the length of the first sub-analysis area can be set according to the effective distance of the first sub-analysis area.

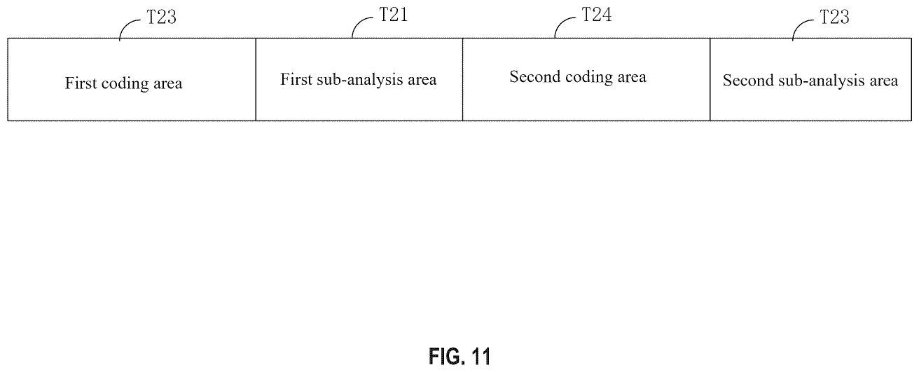

In an embodiment of the present application, refer to FIG. 11, which is a schematic diagram of the division of the analysis area provided in another embodiment of the present application. As shown in FIG. 11, the above-mentioned analysis area T2 can be divided into a first coding area T23, a first sub-analysis area T21, a second coding area T24, and a second sub-analysis area T22.

The first coding area T23 and the second coding area T24 adopt channel coding. Considering that there may be crosstalk between the analysis areas, the first coding area T23 and the second coding area T24 can adopt a superimposed finite length non-fixed offset coding sequence.

In an embodiment, the first coding area T23 may adopt channel coding Ch_a(n, i), offset coding Cb_a(m, i), and high-reflectivity coding Cs_a(l, i); the second coding area may adopt channel coding Ch_b(k, i), offset coding Cb_b(r, i), and high-reflectivity coding Cs_b(p, i), where i represents the channel index.

Offset coding is configured to isolate the crosstalk between the analysis intervals, so the same code value is configured for all channels in the same transmission cycle, that is, Cb_a(m,i)=Cb_a(m), Cb_b(r, i)=Cb_b(r).

The code length of the offset coding of the first coding area T23 and the code length of the offset coding of the second coding area T24 can be equal or unequal, that is, Cb_a(m) and Cb_b(r) can be equal or unequal, taking equal length as an example, that is, Cb_a(m)=Cb_max-Cb_b(m), m=1, . . . . M. Cb_max represents the maximum value of the offset coding.

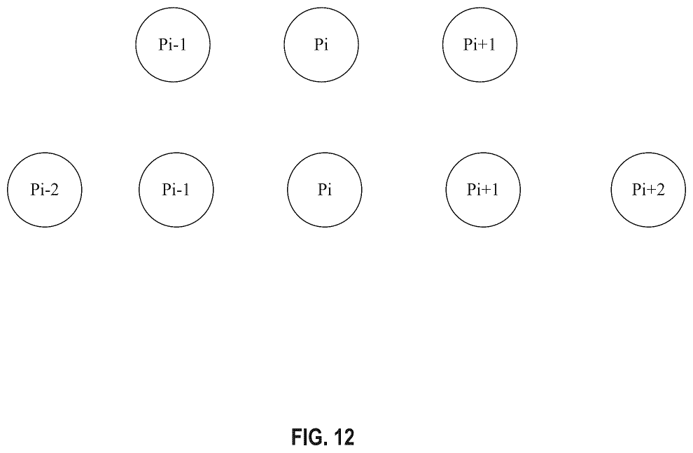

The length of the channel coding is determined by the isolation of the non-high-reflectivity echo crosstalk and the size of the neighborhood similarity judgment window. As shown in FIG. 12, the neighborhood similarity judgment window can adopt a 1*3 pixel time window or a 1*5 pixel time window.

Since the transmission preamble crosstalk may cause blinding in a specific distance segment, it is necessary to ensure that the blinding distance is non-continuous in space during transmission. Taking the maximum code length N as an example, the combined sequence of channel coding and high-reflectivity coding in the transmission coding is C(n), n=1, . . . , N. The following constraints must be met:
dij=Ci−Cj, i>j, i=1, . . . , N, j=1, . . . , N
dn=sort(dij), n=1, . . . , N(N−1)/2
dm=dn+1−dn, n=1, . . . , N(N−1)/2−1, m=1, . . . , N(N−1)/2−1
satisfy dm≥dmin. Sort( ) represents sorting from small to large, diff( ) represents differential calculation, and dmin represents the minimum code interval. dij represents the code spacing, and dn represents the code spacing sorting.

The minimum code interval is usually quantified according to the maximum echo width, such as, it can be set to be greater than or equal to 1.5 times the maximum echo width.

In an embodiment of the present application, taking the application method shown in FIG. 7 as an example, since the first sub-analysis area does not participate in ranging, the first coding area can only adopt offset coding to isolate the crosstalk between the analysis areas. Taking the application method shown in FIG. 8 as an example, since the first sub-analysis area participates in distance measurement, the first coding area and the second coding area both need to introduce offset coding, channel coding, and high-reflectivity coding. The channel coding and high-reflectivity coding of the first coding area and the second coding area can be configured in the same way.

In other embodiments, the above-mentioned transmission cycle can also include three analysis areas or four analysis areas, and FIG. 7 is only an example of the first sub-analysis area and the second sub-analysis area.

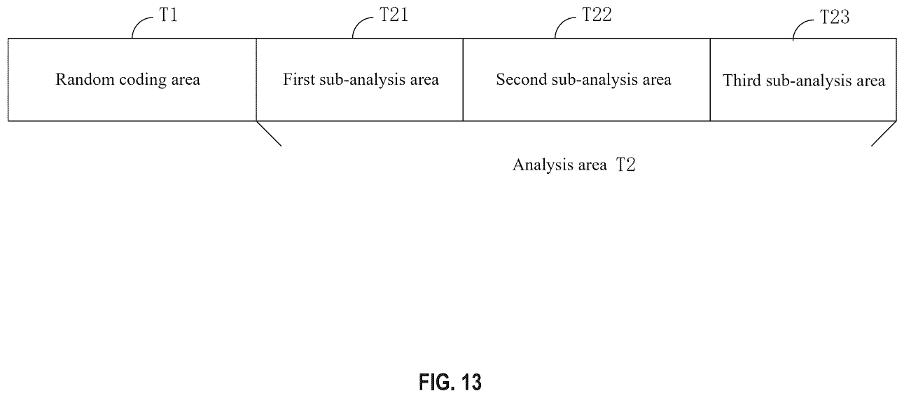

In an embodiment, refer to FIG. 13, which shows another schematic diagram of the division of transmission cycle. As shown in FIG. 13, the above-mentioned transmission cycle T may include a random coding area and an analysis area, and the analysis area may include a first sub-analysis area, a second sub-analysis area, and a third sub-analysis area.

The transmission energy of the first sub-analysis area is less than the transmission energy of the second sub-analysis area, and the transmission energy of the second sub-analysis area is less than the transmission energy of the third sub-analysis area.

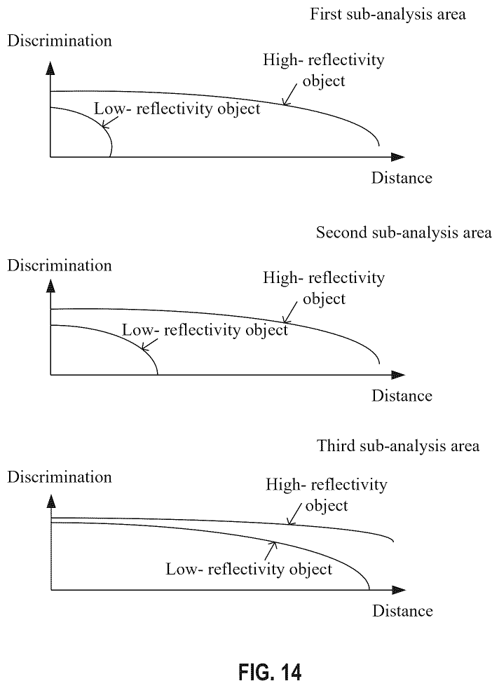

Refer to FIG. 14, which shows a schematic diagram of the discrimination of objects with different reflectivity corresponding to different analysis areas in the transmission cycle shown in FIG. 13. As shown in FIG. 14, the first sub-analysis area (i.e., the area with the smallest transmission energy) has better discrimination for objects at close range than other analysis areas, and other analysis areas can achieve farther ranging.

In S12, determining the transmission coding mode of the next transmission cycle according to the received echo data, and controlling the radar to transmit the detection signals again at the beginning of the next transmission cycle based on the transmission coding mode of the next transmission cycle.

In embodiments of the present application, according to different application modes of the analysis area, the application strategies of the echo data corresponding to the different analysis areas can be determined. Such as, the echo data of the first sub-analysis area can be configured to identify reflectivity objects at close range.

In a specific application, the first M echoes with the strongest echo intensity are selected as the candidate sequence from the echo data of the first sub-analysis area, and the distance information and width information of the candidate echo are obtained from the echo data of the second sub-analysis area. Then, the echo with the highest confidence is pointed out according to the echo intensity, spatial similarity, etc., which can be a single echo or a double echo. Then, the distance and width of the echo with the highest confidence are determined, and the distance range is determined according to the distance and width. According to the distance range, the echo with matching distance is searched from the candidate sequence of the first sub-analysis area.

In searching for the echo with matching distance from the candidate sequence of the first sub-analysis area according to the distance and width, it is to find whether there is an echo in the distance range of [d, d+w], where d is the distance of the echo with the highest confidence, and w is the width of the echo with the highest confidence.

In the process of searching for distance-matched echoes from the candidate sequence of the first sub-analysis area according to the distance range, the following situations may exist:
1. No echo is matched; at this time, the reflectivity defaults to the minimum reflectivity, and the high-reflectivity identification result is that no high reflectivity object is identified.
2. An echo is matched within the distance range; the reflectivity is mapped according to the width of the matched echo, and whether it is a high reflectivity object is determined according to the result of the mapped reflectivity.
3. Two or more echoes are matched within the distance range, and the reflectivity is mapped according to the width of the farthest echo, and whether it is a high reflectivity object is determined according to the result of the mapped reflectivity.

In an embodiment of the present application, the above S12 may include:
if it is determined that there is a high-reflectivity channel according to the echo data, the transmission coding of the analysis area of the high-reflectivity channel is switched to the high-reflectivity coding.

In a specific application, when it is determined that there is a high-reflectivity channel according to the echo data, the transmission coding of the analysis area of the high-reflectivity channel can be switched from the channel coding to the high-reflectivity coding, so that the high-reflectivity coding can be configured to resist crosstalk, thereby improving the anti-crosstalk capability of the radar system.

The radar control method provided in embodiments of the present application divides the radar transmission cycle into a random coding area and an analysis area, and the analysis area includes at least two sub-analysis areas. The random coding area is configured to control the overall offset of the analysis area in the current measurement cycle. Different sub-analysis areas have different transmission energies, so that the echo data of the sub-analysis area with lower transmission energy can be configured to realize the reflectivity identification of close-range objects and the identification of high reflectivity objects, and the echo data of the analysis area with higher transmission energy can be configured to realize ranging and the reflectivity recognition of long-range objects, so that the identification of high reflectivity objects can be effectively improved, the accuracy of high-reflectivity coding switching can be improved, and the probability of crosstalk can be reduced as much as possible.

The size of the serial numbers of the steps in the above embodiments does not mean the order of execution. The execution order of each process should be determined by its function and internal logic.

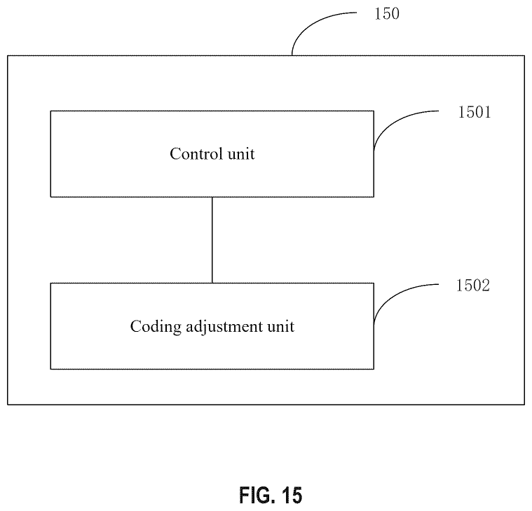

Refer to FIG. 15, which is a schematic diagram of the structure of a radar control device provided in an embodiment of the present application. In an embodiment of the present application, each unit included in the radar control device is configured to execute each step in the embodiment corresponding to FIG. 5. Refer to FIG. 5 and the relevant description in the embodiment corresponding to FIG. 5 for details. For the convenience of explanation, only the part related to the present embodiment is shown. As shown in FIG. 15, the above-mentioned radar control device 150 may include a control unit 1501 and a coding adjustment unit 1502, where:
the control unit 1501 is configured to control the radar to transmit detection signals based on a preset transmission coding mode; the preset transmission coding mode is to control the radar to transmit detection signals according to the transmission code corresponding to the transmission interval in the current transmission cycle, where the transmission cycle includes a random coding area and an analysis area.

The coding adjustment unit 1502 is configured to determine the transmission coding mode of the next transmission cycle according to the received echo data, and control the radar to transmit the detection signals again at the beginning of the next transmission cycle based on the transmission coding mode of the next transmission cycle.

In some embodiments, the above-mentioned coding adjustment unit 1052 includes a high-reflectivity identification unit and an adjustment unit. Where:
the high-reflectivity identification unit is configured to identify high reflectivity objects based on the echo data of the analysis area; and
the adjustment unit is configured to adjust the transmission coding mode of the analysis area of the next transmission cycle of the identified high-reflectivity channel to high-reflectivity coding.

In some embodiments, the analysis area includes at least two sub-analysis areas, and the transmission energies of different sub-analysis areas are different.

In some embodiments, the above-mentioned analysis area may include a first sub-analysis area and a second sub-analysis area; the transmission energy of the first sub-analysis area is less than that of the second sub-analysis area, the echo data corresponding to the first sub-analysis area is configured for identification of high reflectivity objects, and the echo data corresponding to the second sub-analysis area is configured for distance measurement.

In some embodiments, the analysis area includes a first sub-analysis area and a second sub-analysis area, the transmission energy of the first sub-analysis area is less than that of the second sub-analysis area, the echo data corresponding to the first sub-analysis area is configured for identification of high reflectivity objects and distance measurement, and the echo data corresponding to the second sub-analysis area is configured for distance measurement.

In some embodiments, the above-mentioned high-reflectivity identification unit is configured to identify high reflectivity objects according to the echo data of the first sub-analysis area and determine the high-reflectivity channel.

The adjustment unit is configured to adjust the transmission coding mode of the second sub-analysis area of the identified high-reflectivity channel to high-reflectivity coding.

In an embodiment, the radar control device further includes a reflectivity identification unit, where the reflectivity identification unit is configured to determine the reflectivity of an object at a reflectivity splicing distance according to the echo data of the first sub-analysis area; and to determine the reflectivity of an object exceeding the reflectivity splicing distance according to the echo data of the second sub-analysis area, where the reflectivity splicing distance is determined according to the transmission energy of the first sub-analysis area.

In some embodiments, the random coding area is configured to jitter the first sub-analysis area or the second sub-analysis area.

The information interaction, execution process and other contents between the above-mentioned units are based on the same concept as the method embodiment of the present application. Their functions and technical effects can be found in the method embodiment part and will not be repeated here.

The radar control method provided in embodiments of the present application can also divide the radar transmission cycle into random coding areas, and the random coding areas are configured to control the overall offset of the analysis area in the current measurement cycle. By introducing random coding areas, anti-reciprocal interference can be effectively achieved, and the probability of crosstalk can be reduced as much as possible.

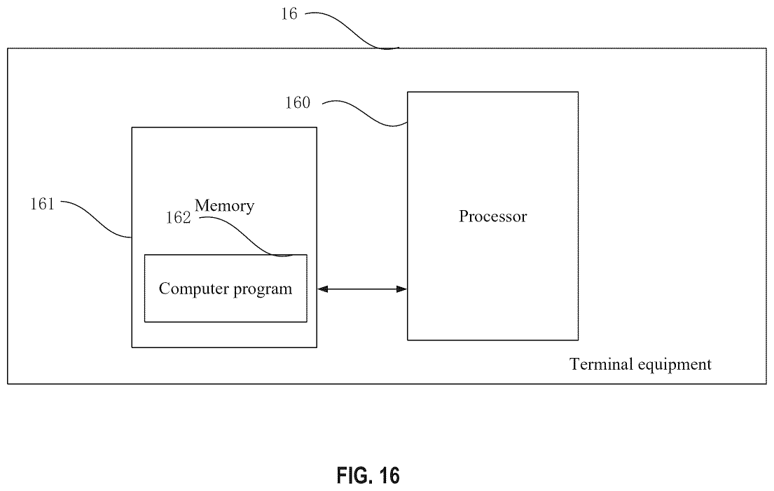

FIG. 16 is a schematic diagram of the structure of a terminal equipment provided in an embodiment of the present application. As shown in FIG. 16, the terminal equipment 16 provided in the embodiment includes: a processor 160, a memory 161, and a computer program 162 stored in the above memory 161 and executable on the above processor 160, such as an image segmentation program. When the processor 160 executes the above computer program 162, the steps in the above radar control method embodiments are implemented, such as S11˜S12 shown in FIG. 5. In some embodiments, when the processor 160 executes the above computer program 162, the functions of each module/unit in the above terminal equipment embodiments are implemented, such as the functions of units 1501˜1502 shown in FIG. 15.

Exemplarily, the computer program 162 may be divided into one or more modules/units, and the one or more modules/units are stored in the memory 161 and executed by the processor 160 to complete the present application. The one or more modules/units may be a series of computer program instruction segments capable of completing specific functions, and the instruction segments are configured to describe the execution process of the computer program 162 in the terminal equipment 16. Such as, the computer program 162 may be divided into an acquisition unit, a determination unit, and a calculation unit. For the specific functions of each unit, refer to the relevant description in the corresponding embodiment of FIG. 7, which will not be repeated here.

The terminal equipment may include, but is not limited to, a processor 160 and a memory 161. The terminal equipment may include more or less components than shown in the figure, or combine certain components, or different components. For example, the terminal device may also include input and output devices, network access devices, buses, etc.

The processor 160 may be a central processing unit (CPU), or other general-purpose processors, digital signal processors (DSP), application-specific integrated circuits (ASIC), field-programmable gate arrays (FPGA), or other programmable logic devices, discrete gate or transistor logic devices, discrete hardware components, etc. A general-purpose processor may be a microprocessor or any conventional processor, etc.

The memory 161 may be an internal storage unit of the terminal equipment 16, such as a hard disk or memory of the terminal equipment 16. The memory 161 may also be an external storage device of the terminal equipment 16, such as a plug-in hard disk, a smart media card (SMC), a secure digital (SD) card, a flash card, etc., equipped on the terminal equipment 16. Further, the memory 161 may also include both an internal storage unit and an external storage device of the terminal equipment 16. The memory 161 is configured to store the computer program and other programs and data required by the terminal equipment. The memory 161 may also be configured to temporarily store data that has been output or is to be output.

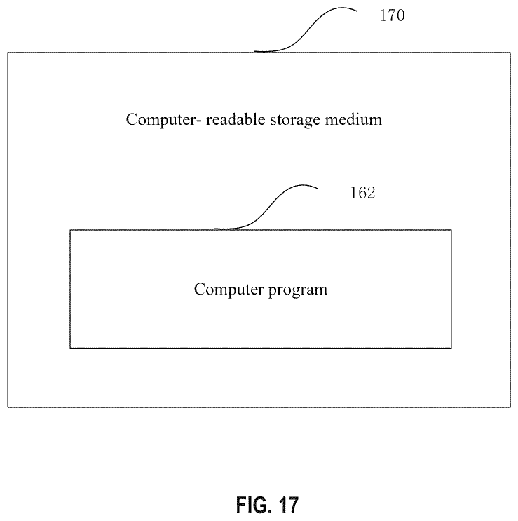

The embodiment of the present application also provides a computer-readable storage medium. Refer to FIG. 17, which is a schematic diagram of the structure of a computer-readable storage medium provided by an embodiment. As shown in FIG. 17, a computer program 162 is stored in the computer-readable storage medium 170, and the computer program 162 can implement the above radar control method when executed by the processor.

The embodiment of the present application provides a computer program product. When the computer program product runs on a terminal equipment, the terminal equipment can implement the above radar control method when executing the computer program product.

In an embodiment, the above-mentioned function allocation can be completed by different functional units and modules as needed, that is, the internal structure of the terminal equipment can be divided into different functional units or modules to complete all or part of the functions described above. The functional units and modules in the embodiment can be integrated into a processing unit, or each unit can exist physically separately, or two or more units can be integrated into one unit. The above-mentioned integrated unit can be implemented in the form of hardware or in the form of software functional units. In addition, the names of the functional units and modules are only for the convenience of distinguishing each other. The working process of the units and modules in the system can refer to the corresponding process in the aforementioned method embodiments.

The units and algorithm steps of each example described in conjunction with the embodiments disclosed herein can be implemented in electronic hardware, or a combination of computer software and electronic hardware. Whether these functions are performed in hardware or software depends on the application and design constraints of the technical solution.

What is claimed is:

1. A radar control method, comprising:
controlling a radar to transmit detection signals based on a preset transmission coding mode, wherein the preset transmission coding mode is configured to control the radar to transmit detection signals according to a transmission code corresponding to a transmission interval in a current transmission cycle, and the current transmission cycle comprises a random coding area and an analysis area; and
determining a transmission coding mode of the next transmission cycle according to received echo data, and controlling the radar to transmit the detection signals again at a beginning of the next transmission cycle based on the transmission coding mode of the next transmission cycle.

2. The radar control method according to claim 1, wherein determining the transmission coding mode of the next transmission cycle according to the received echo data comprises:
identifying a high reflectivity object according to echo data of the analysis area; and
adjusting the transmission coding mode of the analysis area of the next transmission cycle of an identified high-reflectivity channel to high-reflectivity coding.

3. The radar control method according to claim 1,
wherein the analysis area comprises at least two sub-analysis areas, and transmission energies of different sub-analysis areas are different.

4. The radar control method according to claim 3,
wherein the analysis area comprises a first sub-analysis area and a second sub-analysis area; transmission energy of the first sub-analysis area is less than transmission energy of the second sub-analysis area; echo data corresponding to the first sub-analysis area is configured for high reflectivity object identification; and echo data corresponding to the second sub-analysis area is configured for distance measurement.

5. The radar control method according to claim 4, wherein determining the transmission coding mode of the next transmission cycle according to the received echo data comprises:
identifying the high reflectivity object according to the echo data of the first sub-analysis area and determining the high-reflectivity channel; and
adjusting the transmission coding mode of the second sub-analysis area of the identified high-reflectivity channel to high-reflectivity coding.

6. The radar control method according to claim 5, further comprising:
determining the reflectivity of an object at a reflectivity splicing distance according to the echo data of the first sub-analysis area; and
determining the reflectivity of an object exceeding the reflectivity splicing distance according to the echo data of the second sub-analysis area, wherein the reflectivity splicing distance is determined according to the transmission energy of the first sub-analysis area.

7. The radar control method according to claim 4,
wherein the random coding area is configured to jitter the first sub-analysis area or the second sub-analysis area.

8. The radar control method according to claim 1,
wherein the random coding area adopts offset coding.

9. A radar control device, comprising:
a control unit, configured to control a radar to transmit detection signals based on a preset transmission coding mode, wherein the preset transmission coding mode is configured to control a radar to transmit the detection signals according to a transmission code corresponding to a transmission interval in a current transmission cycle, and the current transmission cycle comprises a random coding area and an analysis area; and
a coding adjustment unit, configured to determine a transmission coding mode of the next transmission cycle according to received echo data, and control the radar to transmit the detection signals again at a beginning of the next transmission cycle based on the transmission coding mode of the next transmission cycle.

10. A terminal equipment, comprising:
a memory storing a computer program; and
a processor coupled to the memory and configured to execute the computer program to perform operations comprising:
controlling a radar to transmit detection signals based on a preset transmission coding mode, wherein the preset transmission coding mode is configured to control the radar to transmit detection signals according to a transmission code corresponding to a transmission interval in a current transmission cycle, and the current transmission cycle comprises a random coding area and an analysis area; and
determining a transmission coding mode of the next transmission cycle according to received echo data, and controlling the radar to transmit the detection signals again at a beginning of the next transmission cycle based on the transmission coding mode of the next transmission cycle.
